(19) United States
(12) Patent Application Publication
(10) Pub. No.: US 2024/0362059 A1
(43) Pub. Date: Oct. 31, 2024

(54) ALLOCATION OF VIRTUAL DEVICE IDENTIFIERS

(71) Applicant: Intel Corporation, Santa Clara, CA (US)

(72) Inventor: Jesse BRANDEBURG, Portland, OR (US)

(21) Appl. No.: 18/771,417

(22) Filed: Jul. 12, 2024

(51) Int. Cl. G06F 9/455; G06F 9/4401

(52) U.S. Cl. CPC G06F 9/45558; G06F 9/4403; G06F 2009/45575

(57) ABSTRACT

Examples described herein relate to at least one memory comprising instructions stored thereon and at least one processor. In some examples, the at least one processor is to: based on boot of a device, determine a first virtual identifier value for a first virtual function (VF) associated with the device based on a first seed value and assign the first virtual identifier value to the first VF and based on occurrence of a reset, determine the same first virtual identifier value for the first VF based on the first seed value and assign the first virtual identifier value to the first VF.

### BACKGROUND

As capabilities of devices, such as network interface devices and accelerators, have increased, various technologies have virtualized the device capabilities so that different virtual machines (VMs) or applications can share use of the device capabilities. Single Root input output (IO) Virtualization (SR-IOV) and Scalable I/O Virtualization (SIOV) allow a physical device to be accessible as multiple virtual devices through a bus or device interface. For a network interface device, according to SR-IOV and SIOV, a physical function (PF) driver allocates virtual function (VF) devices to Ethernet ports of the network interface device.

### BRIEF DESCRIPTION OF THE DRAWINGS

FIG. 1 depicts an example system.

FIG. 2 depicts an example operation.

FIG. 3 depicts an example code segment.

FIG. 4 depicts an example process.

FIG. 5 depicts an example network interface device.

FIG. 6 depicts an example system.

### DETAILED DESCRIPTION

A PF driver can allocate media access control (MAC) addresses for Ethernet ports to particular VFs so that communications from the network interface device are routed to the particular VFs. If the PF driver allocates randomly generated MAC addresses for Ethernet ports to VF devices, when a VF driver loads or a virtual machine (VM) or host reboots, such randomly generated MAC address values can change. However, changing of MAC address values can create incompatibility between the VM and the network interface device.

Various examples utilize a seed value for a device so that assignments of virtual device identifiers to the device are retained after a reset of the device or host system. For example, a host-executed driver can perform an operation that generates virtual MAC addresses of the device for the VFs based on the seed value and index value or row value. The operation can utilize a seed value to generate a unique pattern of values and the operation can generate patterns of values with no overlap for different unique seed values, in a repeatable manner. For example, the operation can be based on linear congruential generator (LCG). A seed value can include one or more of: a MAC address of the device, a cryptographic key associated with the device, a Universally Unique Identifier (UUID) associated with the device, Globally Unique Identifier (GUID) associated with the device, Peripheral Component Interconnect Express (PCIe) bus device function (BDF) value, Process Address Space ID (PASID), or other values. Accordingly, a unique set of virtual device identifiers can be assigned to VFs, in a repeatable manner, based solely on storage of the seed value and index value in a persistent or non-volatile memory. Storing merely a seed value and index value instead of storing virtual device identifiers assigned to various VFs can reduce an amount of memory allocated to store virtual device identifiers assigned to VFs.

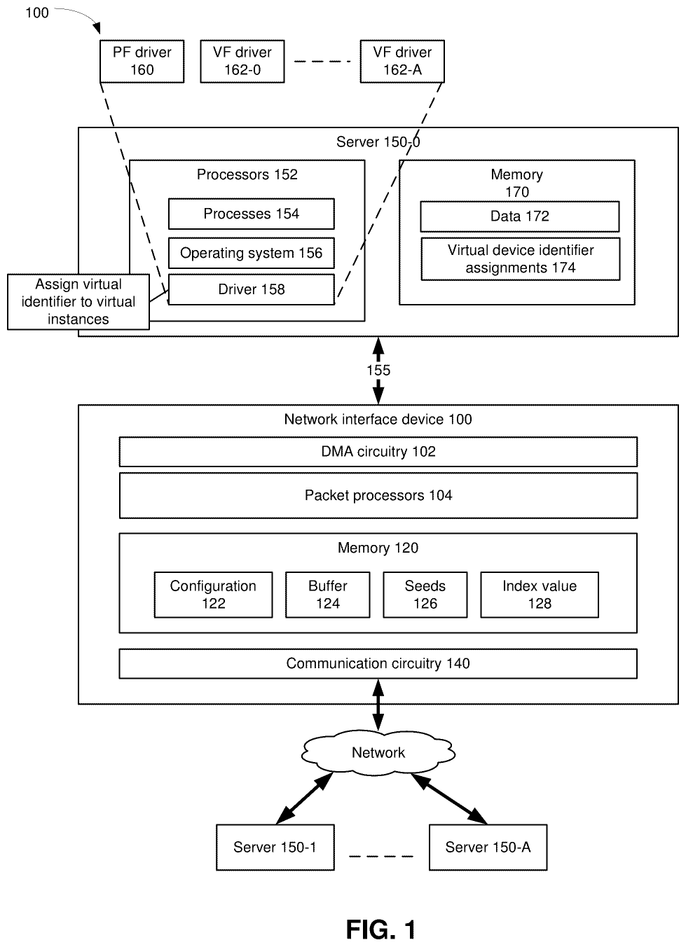

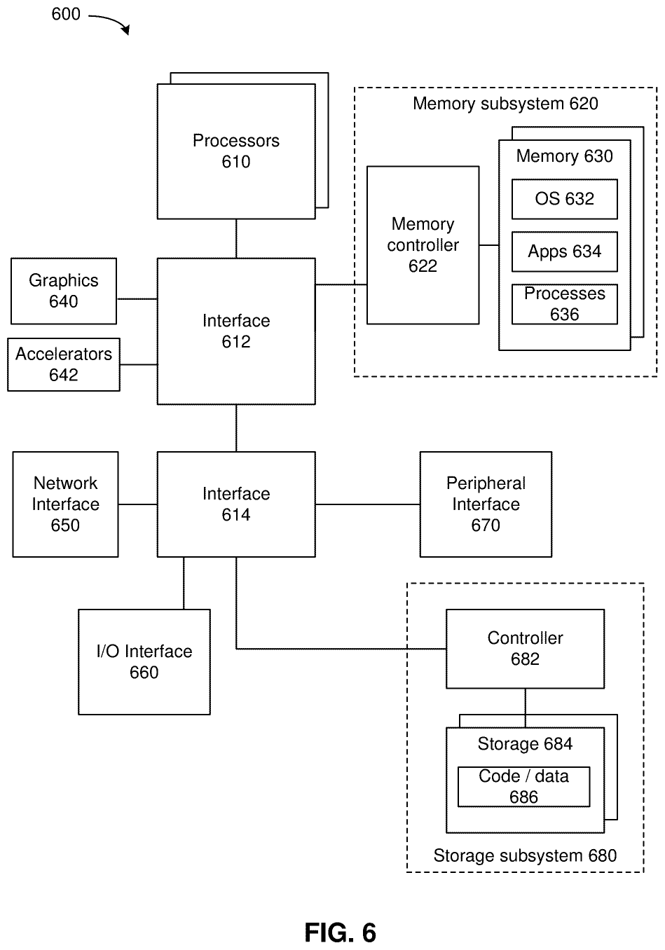

FIG. 1 depicts an example system. One or more of servers 150-0 to 150-A can include processors 152, memory 160, and other circuitry and/or software described herein at least with respect to the system of FIG. 6. Processors 152 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry.

Processors 152 can execute processes 154. A process 154 can include one or more of: application, process, thread, a virtual machine (VM), microVM, container, microservice, or other virtualized execution environment. Processes 154 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Processes 154 can perform operations associated with artificial intelligence (AI) or machine learning (ML) operations such as collective operations or operations of a kernel.

Various examples of collective operations include: broadcast (e.g., distribute data to multiple processing units), AllReduce, reduce (e.g., collect data or partial results from processors and perform an operator on the data or partial results), prefix-sum or scan operation (e.g., collect data or partial results from processors, perform an operator on the data or partial results, and provide the results of the operator to the processors), barrier (e.g., wait for processors to call a barrier), gather (e.g., store data from multiple processors on a single processor), AllGather (e.g., collect data from multiple processors and to store the collected data on the multiple processors), scatter (e.g., distribute data from a processor to multiple processors), a combination thereof, or others.

A kernel layer can include one or more operations. Various examples of operations include at least: forward pass, compute loss, backward pass, error function, loss function, update weights, ReduceScatter, AllGather, or others. Examples of forward pass or forward propagation can calculate a model's predictions with true values or train data from input layer to output layer. Examples of backward pass or backward propagation can calculate a gradient using an average of a sum of losses or differences between the model's predictions and true values or train data, from output layer to input layer. Examples of an error function or loss function can include determination of one or more of: Mean Square Error (MSE)/L2 loss, Mean Absolute Error (MAE)/L1 loss, binary cross-entropy loss/log loss, categorical cross-entropy loss, hinge loss, huber loss/smooth mean absolute error, or log loss.

Processors 152 can include a system agent or uncore (not shown) that can include or more of a memory controller, a shared cache (e.g., last level cache (LLC)), a cache coherency manager, arithmetic logic units, floating point units, core or processor interconnects, Caching/Home Agent (CHA), interface circuitry (e.g., fabric, memory, device), and/or bus or link controllers. A system agent or uncore can provide one or more of: direct memory access (DMA) engine connection, non-cached coherent master connection, data cache coherency between cores and arbitrates cache requests, or Advanced Microcontroller Bus Architecture (AMBA) capabilities.

Processors 152 can execute operating system 156 and/or driver 158. For example, when PF driver 158 loads, PF driver 158 can assign MAC addresses to VFs. For example, loading of PF driver 158 by processor 152 can occur at least at: boot of network interface device 100, reset of network interface device 100, boot or reboot of server 150-0, reloading PF driver 158, de-initializing a SR-IOV interface, or others.

In some examples, driver 158 can generate unique pattern of values with no overlap for different unique seed values, in a repeatable manner. In some examples, driver 158 can generate virtual device identifiers (e.g., MAC addresses) for network interface device 100 by use of a linear congruential generator (LCG) using one or more of seed values 126 and assign the virtual device identifiers to VFs. Seed values 126 can be stored in a persistent or non-volatile memory of memory 120 and assigned for a duration of time to network interface device 100. Memory 120 can be in a same system on chip (SoC) as that of network interface device 100 or connected to network interface device 100 via an interface. For example, seed values 126 can include at least one fixed, device-specific seed, or a number that is unique to device 100, including one or more of: a MAC address of the device, a cryptographic key associated with the device, a UUID associated with the device, a GUID associated with the device, a PCIe bus device function BDF value associated with the device, a PASID associated with the device, or other values. For example, network interface device 100 can be associated with multiple MAC addresses, such as at least one MAC address per port. PF driver 158 can store virtual device identifiers assigned to VFs in virtual device assignments 174, in volatile memory, for access by a VF to determine a virtual device identifier.

Accordingly, after restart or reboot of server 150-0 or network interface device 100, a VF can be assigned a consistent virtual device identifier associated with network interface device 100 and the virtual device identifier need not be stored in permanent storage or in a software configuration. A VF can refer to at least a switch port of a MAC controller, SR-IOV VF, SIOV Assignable Device Interface (ADI), a Linux subfunction, or other virtual port. A VF can be connected to an internal switch of network interface device 100 as an endpoint. A first end of the MAC controller or switch can include a physical port and a second end of the MAC controller or switch can be associated with a VF.

For example, use of LCG can generate a virtual device identifier for a VF based on a recurrent relationship such as:
Xₙ₊₁=(aXₙ+c) mod m, where:
   X is a sequence of pseudo-random values,
   m, 0<m,

$$a , 0 < a < m ,$$

$$c , 0 \leq c < m , and$$

$${X}_{0} , 0 \leq {X}_{0} < m .$$

Alternatives to LCG can include multiplicative linear congruential generator (MLCG), multiplicative congruential generator (MCG), Lehmer random number generator (RNG), mixed congruential generator, or other processes that generate unique pattern of values with no overlap for different unique seed values, in a repeatable manner.

Table 1 shows an example of values generated based on seed values. Selection of a value can be based on an index value. The index value can be stored in persistent memory (e.g., index value 128 in memory 120) to select a device identifier for a particular seed value.

TABLE 1

Seed value

| index | 2 | 3 |
|---|---|---|
| 0 | 0 | 1 |
| 1 | 2 | 3 |
| 2 | 4 | 5 |
| 3 | 6 | 7 |
| 4 | 8 | 9 |
| 5 | 10 | 11 |
| . . . | | |
| 128 | 256 | 385 |

Although examples are provided with respect to assignment of virtual device identifier values to a network interface device, other devices can be used instead or in addition, such as a storage controller, memory controller, fabric interface, processor, PCIe connected device, and/or accelerator device.

One or more of servers 150-0 to 150-A, where A is an integer, can be coupled to network interface device 100 using a device interface 155 or network connection. For example, via interface 155, processors 152 and/or other circuitry can access network interface device 100 via communications consistent with Peripheral Component Interconnect Express (PCIe), Compute Express Link (CXL), Universal Chiplet Interconnect Express (UCIe), Single Root I/O Virtualization (SR-IOV), or Scalable Input/Output (I/O) Virtualization (S-IOV) virtual device. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. Single Root I/O Virtualization (SR-IOV) and Sharing specification, version 1.1, published Jan. 20, 2010 specifies hardware-assisted performance input/output (I/O) virtualization and sharing of devices. Intel® Scalable I/O Virtualization (S-IOV) permits configuration of a device to group its resources into multiple isolated Assignable Device Interfaces (ADIs). Direct Memory Access (DMA) transfers from/to an ADI are tagged with a unique Process Address Space identifier (PASID) number. An example technical specification for SIOV is Intel® Scalable I/O Virtualization Technical Specification, revision 1.0, June 2018, as well as earlier versions, later versions, and variations thereof.

Referring to network interface device 100, packet processors 104 can process data to be transmitted to server 150-0 to 150-A or received from server 150-0 to 150-A by performing one or more of: encryption, decryption, data compression, data decompression, data or device authentication, next hop determination, error value checking (e.g., cyclic redundancy check (CRC) or checksum), trust verification, or others.

In some examples, network interface device 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An EPU can include a network interface device that utilizes processors and accelerators (e.g., digital signal processors (DSPs), signal processors, or wireless specific accelerators for Virtualized radio access networks (vRANs), cryptographic operations, compression/decompression, and so forth). A network interface device can include: one or more processors; one or more programmable packet processing pipelines; one or more accelerators; one or more application specific integrated circuits (ASICs); one or more field programmable gate arrays (FPGAs); one or more memory devices; one or more storage devices; or others.

Packet processors 104 can be implemented as one or more of: a processor core, field programmable gate array (FPGA), a processor that executes instructions, firmware, application specific integrated circuit (ASIC), or other circuitry.

Communication circuitry 112 can provide communications with other devices over a network or fabric via one or more ports. Communication circuitry 112 may be configured to use any one or more communication technology (e.g., wired or wireless communications) and associated protocols (e.g., Ethernet, InfiniBand®, Bluetooth®, Wi-Fi®, 4G LTE, 5G, Ultra Ethernet, etc.) to perform such communication. Communication circuitry 112 can include one or more network hardware resources, such as ingress queues, egress queues, crossbars, shared memory switches, media access control (MAC), physical layer interface (PHY), Ethernet port logic, and other network hardware resources.

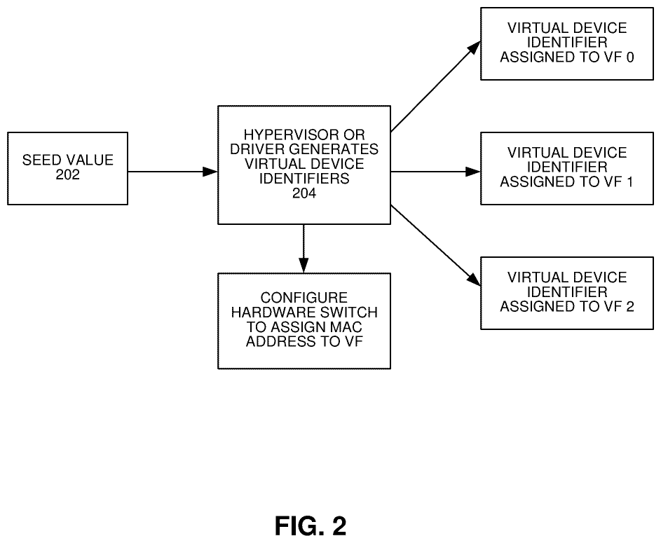

FIG. 2 depicts an example of assignments of virtual device identifiers to VFs. For example, based on a seed value 202, stored in non-volatile memory, at 204, hypervisor or PF driver can assign a virtual device identifier (e.g., MAC address) to a VF. Seed value 202 can be a MAC address associated with a network interface device or other device. The PF driver can store a table assigning MAC addresses to VFs (e.g., virtual device identifier assignments 174). A PF driver can configure a hardware switch (e.g., MAC controller) to communicate with the MAC address assigned to a VF so that packets assigned to a particular MAC address are routed correctly to the MAC address associated with a VF. A VF driver (e.g., Intel® Ethernet Adaptive Virtual Function (IAVF)) can access an assignment of a virtual device identifier (e.g., MAC address) by querying PF driver (e.g., via virtchannel). Accordingly, for multiple launches of a device, MAC addresses or other virtual identifiers associated with a VF can be the same.

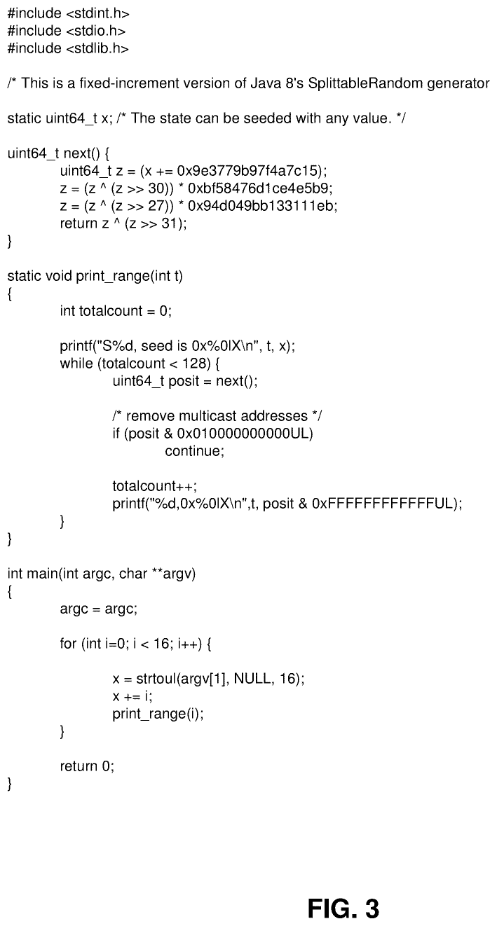

FIG. 3 depicts an example code segment. Execution of the code segment can generate unique MAC addresses for multiple different seed values (e.g., 16 seed values). Variable x can represent a seed value. Instruction int main (int argc, char **argv) can call print_range (int t) to output the virtual device identifiers (e.g., MAC addresses). Iteration of uint64_t next ( ) can create constants based on a value of variable x. Instruction printf(“% d,0x %01X\n”,t, posit & 0xFFFFFFFFFFFFUL) can remove multicast addresses and truncate a value posit to generate a MAC address to assign to a VF.

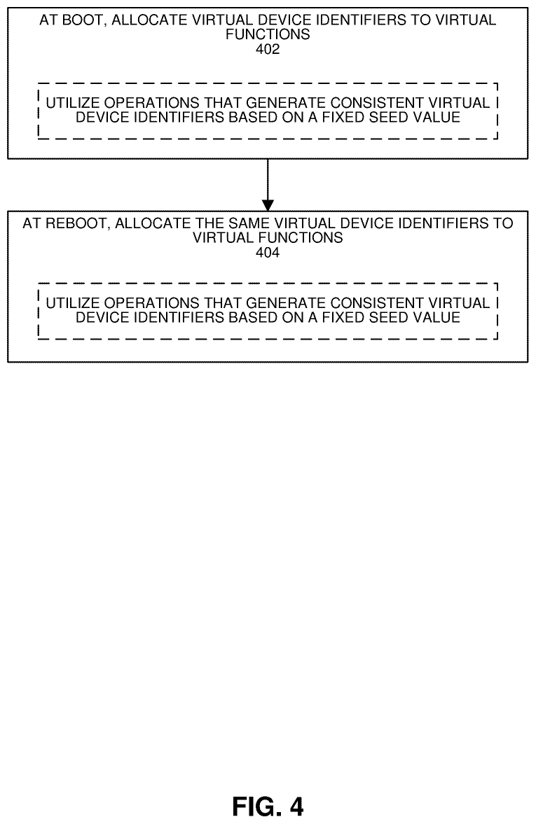

FIG. 4 depicts an example process. The process can be performed by a driver for a device. The device can include one or more of: a network interface device, storage controller, memory controller, fabric interface, processor, PCIe connected device, and/or accelerator device. At 402, at a boot of a host system and discovery of a connected device, one or more virtual function identifiers can be assigned to the device to provide sharing of use of the device to one or more processes. For example, an operation to generate the one or more virtual function identifiers can utilize a seed value. In some examples, the operation can include an LCG operation or other operation. In some examples, the seed value can include a MAC address of the device, a cryptographic key associated with the device, a UUID associated with the device, a GUID associated with the device, or other values.

At 404, at reboot, an operation can be performed to generate the one or more virtual function identifiers to assign to the same one or more processes based on a seed value. For example, reboot can occur at one or more of: reboot of a host system, reboot of the device, loading a PF driver, reloading a PF driver, or other triggers. The operation and seed value can be the same as that utilized in 402. Accordingly, a unique set of virtual device identifiers can be assigned to VFs in a repeatable manner based on a seed value without storing virtual device identifiers assigned to various VFs in non-volatile memory.

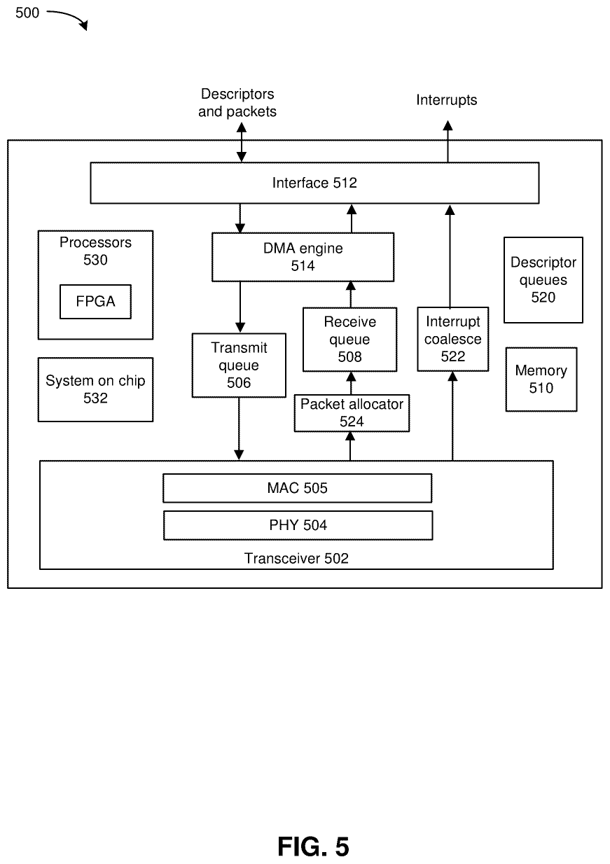

FIG. 5 depicts an example network interface device. Some examples of network interface 500 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable circuitries or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 530, transmit queue 506, receive queue 508, memory 510, and host interface 512, and DMA engine 514. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 504 and media access control (MAC) circuitry 505. PHY circuitry 504 can include encoding and decoding circuitry (not shown) to encode and decode data packets according to applicable physical layer specifications or standards. MAC circuitry 505 can be configured to perform MAC address filtering on received packets, process MAC headers of received packets by verifying data integrity, remove preambles and padding, and provide packet content for processing by higher layers. MAC circuitry 505 can be configured to assemble data to be transmitted into packets, that include destination and source addresses along with network control information and error detection hash values.

Processors 530 can be one or more of: combination of: a processor, core, graphics processing unit (GPU), field programmable gate array (FPGA), application specific integrated circuit (ASIC), or other programmable hardware device that allow programming of network interface 500. For example, a “smart network interface” or SmartNIC can provide packet processing capabilities in the network interface using processors 530.

Processors 530 can include a programmable processing pipeline or offload circuitries that is programmable by P4, Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content.

Packet allocator 524 can provide distribution of received packets for processing by multiple CPUs or cores using receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 514 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be volatile and/or non-volatile memory device and can store any queue or instructions used to program network interface 500. Transmit traffic manager can schedule transmission of packets from transmit queue 506. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with or based at least in part on PCI, PCIe, PCI-x, Serial ATA, and/or USB (although other interconnection standards may be used), or proprietary variations thereof.

FIG. 6 depicts a system. In some examples, circuitry of system 600 can be configured to generate virtual device identifiers for a device using a seed value and assign the virtual device identifiers to VFs, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can generate virtual device identifiers for a device (e.g., network interface 650, graphics 640, accelerator 642, or others) using a seed value and assign the virtual device identifiers to VFs, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), data processing unit (DPU), EPU, or others.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), RoCE v2, Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute platforms of processors, memories, storages, network interfaces, and other components. High speed interconnects can be used such as PCIe, CXL, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples and includes at least one non-transitory computer-readable medium, comprising instructions stored thereon, that if executed by one or more processors, cause the one or more processors to: execute a driver that is to: based on boot of a device, determine a first media access control (MAC) address value for a first virtual function (VF) based on a first seed value and assign the first MAC address value to the first VF and determine a second MAC address value for a second VF based on a second seed value and assign the second MAC address value to the second VF and based on occurrence of a reset, determine the same first MAC address value for the first VF based on the first seed value and assign the first MAC address value to the first VF and determine the same second MAC address value for the second VF based on the second seed value and assign the second MAC address value to the second VF.

Example 2 includes one or more examples, wherein the reset is based on one or more of: host reboot, reboot of the device, or reloading of the driver.

Example 3 includes one or more examples, wherein: based on the boot of the device and the occurrence of the reset: to determine the first MAC address value, the driver is to apply a linear congruential generator (LCG) based at least on the first seed value and to determine the second MAC address value, the driver is to apply the LCG based at least on the second seed value.

Example 4 includes one or more examples, wherein: the driver is to access the first seed value and the second seed value from non-volatile memory the determine the first MAC address value and the second MAC address value is based on generation of values with no overlap for different seed values.

Example 5 includes one or more examples, wherein: the first seed value is based on one or more of: a MAC address of the device, a cryptographic key associated with the device, a Universally Unique Identifier (UUID) associated with the device, or Globally Unique Identifier (GUID) associated with the device.

Example 6 includes one or more examples, wherein: the first VF is consistent with one or more of: single-root input/output (I/O) virtualization (SR-IOV) or scalable I/O virtualization (SIOV), or Linux subfunction and the first VF comprises one or more of: a switch port of a MAC controller, SR-IOV VF, SIOV ADI, a Linux subfunction, or virtual port.

Example 7 includes one or more examples, wherein the driver comprises a physical function (PF) driver consistent with one or more of: SR-IOV or SIOV.

Example 8 includes one or more examples, wherein the device comprises one or more of: a network interface device, a storage controller, a memory controller, or an accelerator.

Example 9 includes one or more examples, and includes an apparatus that includes: at least one memory comprising instructions stored thereon and at least one processor, that based on execution of the instructions, is to: based on boot of a device, determine a first virtual identifier value for a first virtual function (VF) associated with the device based on a first seed value and assign the first virtual identifier value to the first VF and based on occurrence of a reset, determine the same first virtual identifier value for the first VF based on the first seed value and assign the first virtual identifier value to the first VF.

Example 10 includes one or more examples, wherein the reset is based on one or more of: host reboot, reboot of the device, or reloading of a driver for the device.

Example 11 includes one or more examples, wherein the determine the first virtual identifier value comprises perform a linear congruential generator (LCG) based on the first seed value.

Example 12 includes one or more examples, wherein the first virtual identifier value comprises a first media access control (MAC) address.

Example 13 includes one or more examples, wherein the first seed value is based on one or more of: a media access control (MAC) address of the device, a cryptographic key associated with the device, a Universally Unique Identifier (UUID) associated with the device, or Globally Unique Identifier (GUID) associated with the device.

Example 14 includes one or more examples, wherein the first VF is consistent with one or more of: single-root input/output (I/O) virtualization (SR-IOV) or scalable I/O virtualization (SIOV) and the first VF comprises one or more of: a switch port of a media access controller (MAC) controller, SR-IOV VF, SIOV ADI, a Linux subfunction, or virtual port.

Example 15 includes one or more examples, wherein the device comprises one or more of: a network interface device, a storage controller, a memory controller, or an accelerator.

Example 16 includes one or more examples, and includes a method comprising: based on boot of a device, determining a first virtual identifier value for a first virtual function (VF) based on a first seed value and assigning the first virtual identifier value to the device and based on occurrence of a reset, determining the same first virtual identifier value for the first VF based on the first seed value and assigning the first virtual identifier value to the first VF.

Example 17 includes one or more examples, wherein the reset is based on one or more of: host reboot, reboot of the device, or reloading of a driver.

Example 18 includes one or more examples, wherein: based on the boot of the device and the occurrence of the reset: determining the first virtual identifier value by applying a linear congruential generator (LCG) based on the first seed value.

Example 19 includes one or more examples, wherein the first seed value is based on one or more of: a media access control (MAC) address of the device, a cryptographic key associated with the device, a Universally Unique Identifier (UUID) associated with the device, or Globally Unique Identifier (GUID) associated with the device.

Example 20 includes one or more examples, wherein the device comprises one or more of: a network interface device, a storage controller, a memory controller, or an accelerator.

What is claimed is:

1. At least one non-transitory computer-readable medium, comprising instructions stored thereon, that if executed by one or more processors, cause the one or more processors to:
execute a driver that is to:
based on boot of a device, determine a first media access control (MAC) address value for a first virtual function (VF) based on a first seed value and assign the first MAC address value to the first VF and determine a second MAC address value for a second VF based on a second seed value and assign the second MAC address value to the second VF and
based on occurrence of a reset, determine the same first MAC address value for the first VF based on the first seed value and assign the first MAC address value to the first VF and determine the same second MAC address value for the second VF based on the second seed value and assign the second MAC address value to the second VF.

2. The at least one non-transitory computer-readable medium of claim 1, wherein the reset is based on one or more of: host reboot, reboot of the device, or reloading of the driver.

3. The at least one non-transitory computer-readable medium of claim 1, wherein:
based on the boot of the device and the occurrence of the reset:
to determine the first MAC address value, the driver is to apply a linear congruential generator (LCG) based at least on the first seed value and
to determine the second MAC address value, the driver is to apply the LCG based at least on the second seed value.

4. The at least one non-transitory computer-readable medium of claim 1, wherein:
the driver is to access the first seed value and the second seed value from non-volatile memory and
the determine the first MAC address value and the second MAC address value is based on generation of values with no overlap for different seed values.

5. The at least one non-transitory computer-readable medium of claim 1, wherein:
the first seed value is based on one or more of: a MAC address of the device, a cryptographic key associated with the device, a Universally Unique Identifier (UUID) associated with the device, or Globally Unique Identifier (GUID) associated with the device.

6. The at least one non-transitory computer-readable medium of claim 1, wherein:
the first VF is consistent with one or more of: single-root input/output (I/O) virtualization (SR-IOV) or scalable I/O virtualization (SIOV), or Linux subfunction and
the first VF comprises one or more of: a switch port of a MAC controller, SR-IOV VF, SIOV ADI, a Linux subfunction, or virtual port.

7. The at least one non-transitory computer-readable medium of claim 6, wherein the driver comprises a physical function (PF) driver consistent with one or more of: SR-IOV or SIOV.

8. The at least one non-transitory computer-readable medium of claim 1, wherein the device comprises one or more of: a network interface device, a storage controller, a memory controller, or an accelerator.

9. An apparatus comprising:
at least one memory comprising instructions stored thereon and
at least one processor, that based on execution of the instructions, is to:
based on boot of a device, determine a first virtual identifier value for a first virtual function (VF) associated with the device based on a first seed value and assign the first virtual identifier value to the first VF and
based on occurrence of a reset, determine the same first virtual identifier value for the first VF based on the first seed value and assign the first virtual identifier value to the first VF.

10. The apparatus of claim 9, wherein the reset is based on one or more of: host reboot, reboot of the device, or reloading of a driver for the device.

11. The apparatus of claim 9, wherein:
the determine the first virtual identifier value comprises perform a linear congruential generator (LCG) based on the first seed value.

12. The apparatus of claim 9, wherein the first virtual identifier value comprises a first media access control (MAC) address.

13. The apparatus of claim 9, wherein:
the first seed value is based on one or more of: a media access control (MAC) address of the device, a cryptographic key associated with the device, a Universally Unique Identifier (UUID) associated with the device, or Globally Unique Identifier (GUID) associated with the device.

14. The apparatus of claim 9, wherein:
the first VF is consistent with one or more of: single-root input/output (I/O) virtualization (SR-IOV) or scalable I/O virtualization (SIOV) and
the first VF comprises one or more of: a switch port of a media access controller (MAC) controller, SR-IOV VF, SIOV ADI, a Linux subfunction, or virtual port.

15. The apparatus of claim 9, wherein the device comprises one or more of: a network interface device, a storage controller, a memory controller, or an accelerator.

16. A method comprising:
based on boot of a device, determining a first virtual identifier value for a first virtual function (VF) based on a first seed value and assigning the first virtual identifier value to the device and
based on occurrence of a reset, determining the same first virtual identifier value for the first VF based on the first seed value and assigning the first virtual identifier value to the first VF.

17. The method of claim 16, wherein the reset is based on one or more of: host reboot, reboot of the device, or reloading of a driver.

18. The method of claim 16, wherein:
based on the boot of the device and the occurrence of the reset:
determining the first virtual identifier value by applying a linear congruential generator (LCG) based on the first seed value.

19. The method of claim 16, wherein:
the first seed value is based on one or more of: a media access control (MAC) address of the device, a cryptographic key associated with the device, a Universally Unique Identifier (UUID) associated with the device, or Globally Unique Identifier (GUID) associated with the device.

20. The method of claim 16, wherein the device comprises one or more of: a network interface device, a storage controller, a memory controller, or an accelerator.
